(19) United States
(12) Patent Application Publication
(10) Pub. No.: US 2018/0288967 A1
(43) Pub. Date: Oct. 11, 2018

(54) Animal feeder

(71) Applicant: Pierre Gagnon, Sherbrooke (CA)

(72) Inventor: Pierre Gagnon, Sherbrooke (CA)

(21) Appl. No.: 15/932,686

(22) Filed: Apr. 10, 2018

Related U.S. Application Data
(60) Provisional application No. 62/602,074, filed on Apr. 11, 2017.

(51) Int. Cl. A01K 5/02; A01K 1/10; A01K 5/01

(52) U.S. Cl. CPC A01K 5/0291; A01K 5/01; A01K 5/0225; A01K 1/105

(57) ABSTRACT

A feeder for a horse or another animal includes a container with an open top end and a closed bottom end, a lid for closing the top end, a bottom opening proximate the lower end of at least one of a front and rear wall of the container, a gate normally closing the opening, a cable connecting the top of the gate to a winch, and a control assembly for periodically operating the winch to wind or unwind the cable on the winch to open the gate at predetermined times during the day permitting access to the feed, and for closing the gate after preselected intervals to prevent further access to the feed.

### FIELD OF THE INVENTION

This invention relates to an animal feeder, and in particular to a horse or other livestock feeder.

### BACKGROUND OF THE INVENTION

In general, horse or other livestock feeders take the form of open troughs or other containers which allow unrestricted access to feed. Examples of such feeders are described in Canadian Patent Application 2,522,237, filed by Robin R. Klene on Oct. 4, 2005 and 2,639,174, filed by Trevor L. Lienemann on Aug. 28, 2008.

### SUMMARY OF THE INVENTION

The feeder of the present invention is designed to feed one or two animals at predetermined times during the day for preselected intervals. In general terms, the feeder includes a stand, a container mounted on the stand, the container including a top opening for receiving animal food such as bales of hay, a bottom opening in at least one wall of the container permitting access to the food, a gate normally closing the opening, a cable attached to the gate, a winch carrying the cable for opening the gate, and a control assembly for periodically operating the winch to open the gate at predetermined times during the day and for closing the gate after the preselected interval. Preferably, the feeder container is rotatable on the stand for rotation between a horizontal feed loading position and a vertical feeding position.

### BRIEF DESCRIPTION OF THE DRAWINGS

The invention is described below in greater detail with reference to the accompanying drawings which illustrate a preferred embodiment of the invention, and wherein:

FIG. 1 is an isometric view of an animal feeder in accordance with the invention;

FIG. 2 is a front view of the animal feeder of FIG. 1;

FIG. 3 is a rear view of the animal feeder of FIGS. 1 and 2;

FIGS. 4 and 5 are side views of the animal feeder of FIGS. 1 to 3;

FIG. 6 is an isometric view of a section of one side of the animal feeder of FIGS. 1 to 5; and

FIG. 7 is an isometric view of a winch used on the horse feeder of FIGS. 1 to 5.

### DETAILED DESCRIPTION OF THE INVENTION

In the following detailed description, the feeder is referred to as a horse feeder. However, depending upon the feed, the feeder can be used to dispense feed to other animals.

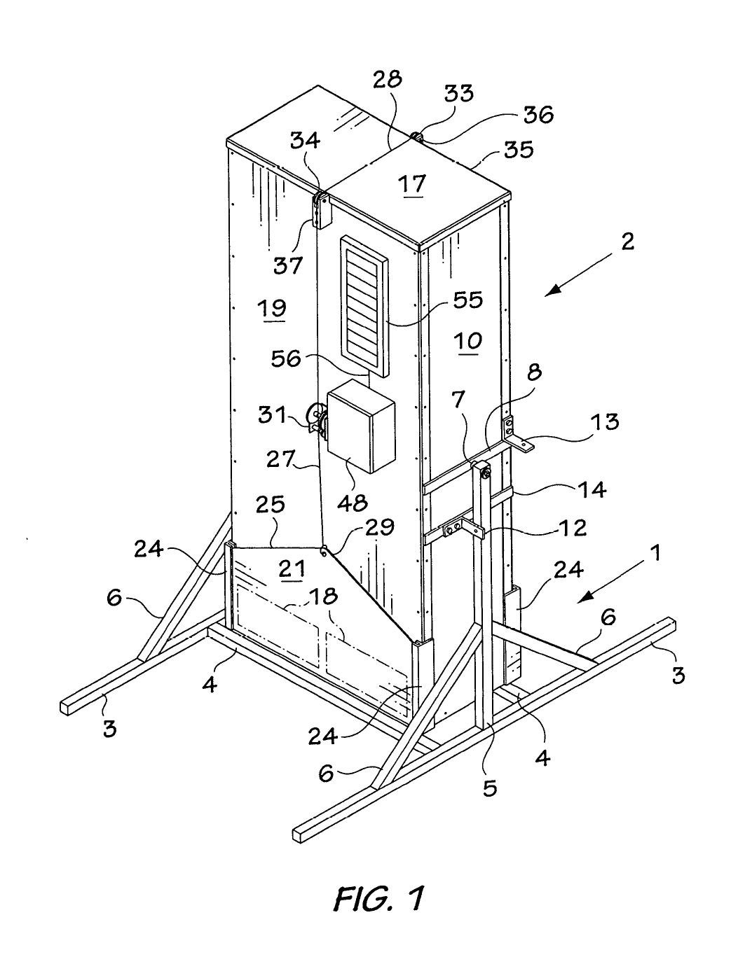

With reference to FIGS. 1 to 5, the basic elements of a horse feeder in accordance with the invention are a stand carrying an elongated, rectangular cross section container which are indicated generally at 1 and 2, respectively.

The stand 1 is made of aluminum tubes and includes a pair of elongated, spaced apart, parallel feet 3 interconnected by a pair of crossbars 4. A post 5 extends vertically upwardly from the center of each foot 3. The posts 5 are maintained in vertical positions by diagonal braces 6.

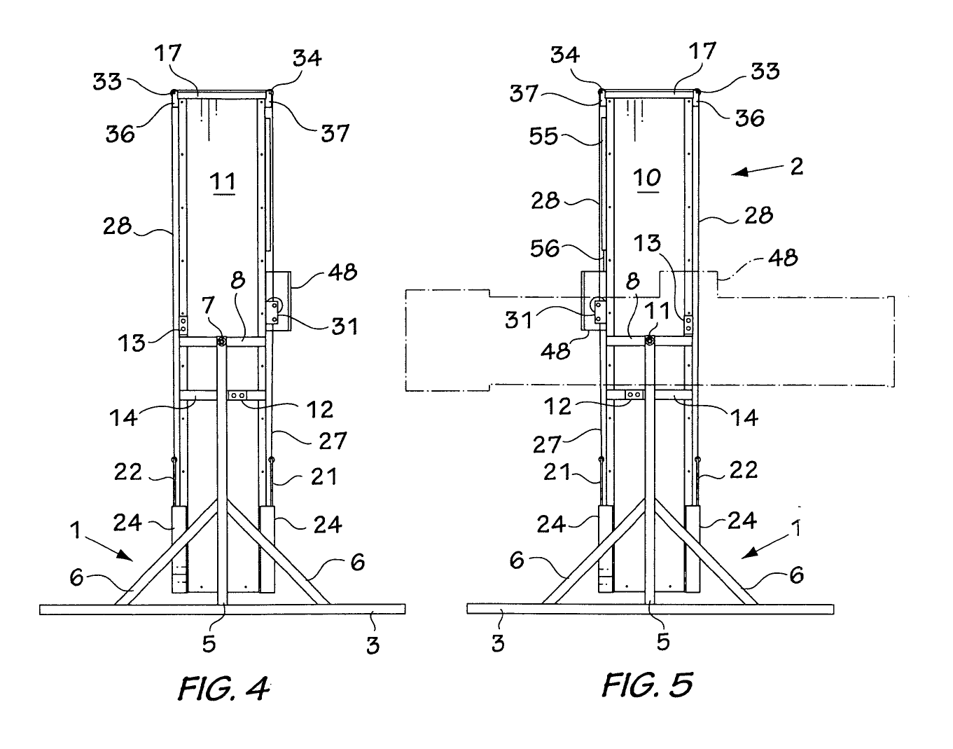

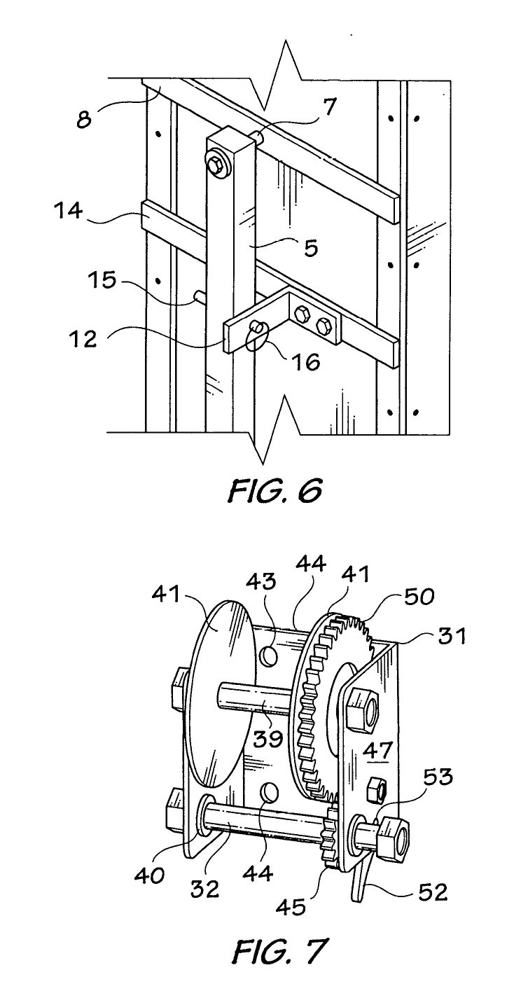

The container 2 is pivotally mounted between the posts 5 on stub axles 7, which extend from crossbars 8 on the sides 10 and 11 of the container 2. The container 2 can be rotated between the vertical, use or feeding position shown in FIGS. 1 to 5 and a horizontal, feed loading position shown in phantom outline in FIG. 3. Movement beyond the feeding and feed loading position is prevented by a pair of L-shaped stops 12 and 13. The vertical limiting stops 12 are mounted on second crossbars 14 on the sides 10 and 11 of the container 2. When the container 2 is in the vertical, feeding position, the outwardly extending arms of the stops 12 bear against the posts 5, preventing rotation of the container beyond the vertical in one direction. When the container 2 is rotated to the horizontal position (counterclockwise in FIGS. 1 and 4, clockwise in FIG. 5), the outwardly extending arms of the stops 13 bear against the posts 6, preventing rotation of the container 2 beyond the horizontal loading position. The container is releasably retained in the vertical, use position or the horizontal, loading position by a pin 15 (FIG. 6), which is inserted through aligned holes (not shown) in an arm of one of the stops 12 or 13 and in one post 5. A handle in the form of a ring 16 (FIG. 6) is provided on the outer end of the pin 15 for facilitating insertion and removal of the pin. Feed, in the form of bales of hay (not shown), is loaded into the container 2 via the open top end of the container which is covered by a lid 17.

The feed is discharged from the container through openings 18 in both the front and rear walls 19 and 20, respectively. Of course, a single opening 18 can be provided in the front or rear wall for feeding a single animal. The openings 18 are normally blocked by gates 21 and 22 on the front and rear of the container 2. The gates 21 and 22 are slidably mounted in tracks 24 connected to the bottom corners of the container 2. The gates 21 and 22 have inverted V-shaped upper ends 25. Cables 27 and 28 extend upwardly from the apexes 29 and 30 of the upper ends of the gates 21 and 22, respectively, to a winch 31. The cable 27 extends directly upwardly to a bottom drum 32 in the winch 31. The cable 28 extends upwardly from the gate 22 around pulleys 33 and 34 mounted in brackets 36 and 37 at the upper ends of the rear and front walls 20 and 19, respectively to a top drum 39 in the winch 31. Discs 40 and 41 are mounted on the drums 32 and 39 for centering the cables 27 and 28 in the winch 31.

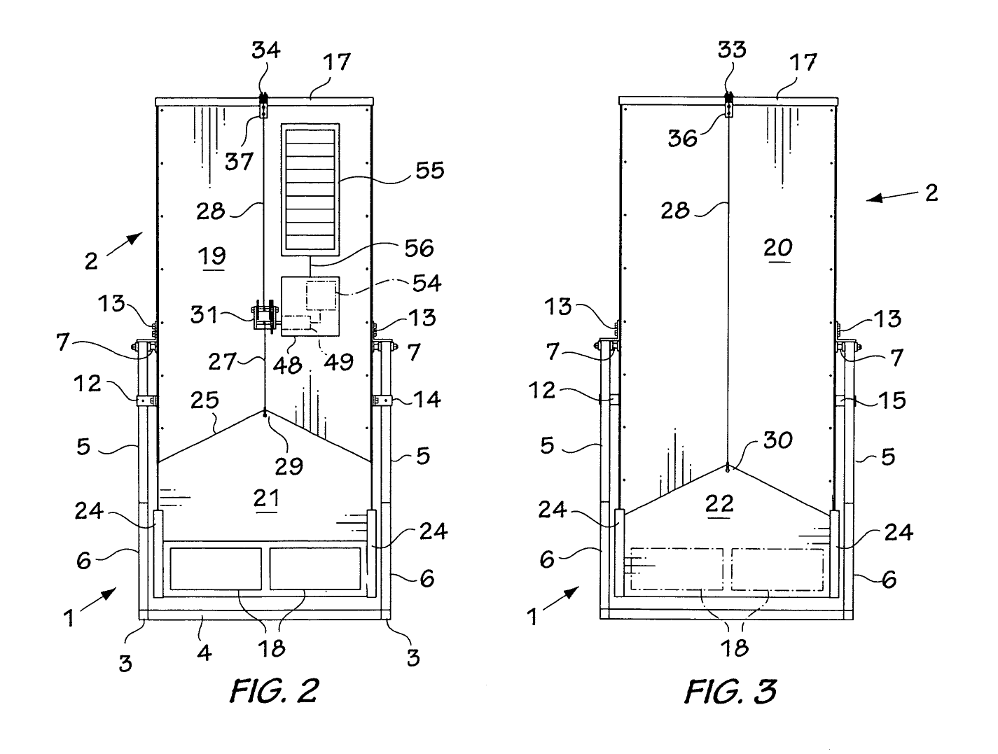

As best shown in FIG. 7, the winch 31 also includes a generally U-shaped housing with holes 43 in a rear wall 44 for mounting the winch on the front wall 19 of the container 2. A toothed wheel 45 is mounted on the drum 32 inside of a side wall 47 of the winch housing. The drum 32, which is defined by a shaft extends through the side wall 47 of the housing into a control assembly which includes a box mounted on the front wall 19 of the container 2. The box 48 containing a reversible motor 49 (FIG. 2) connected to the outer end of the winch drum 32 for rotating the latter. A second toothed wheel 50 is mounted on one end of the upper drum 39 and meshes with the lower toothed wheel 45. While the drum 32 and the toothed wheel 45 rotate in one direction, the drum 39 and the toothed wheel 50 rotate in the opposite direction, whereby the gates 22 and 23 are simultaneously raised or lowered. The toothed wheels 33 and 39 can be releasably locked in one position by an optional pawl 52 pivotally mounted on a pin 53 extending through the side wall 47 of the side wall 47 of the winch housing for engaging the teeth on the wheel 45.

As well as the motor 49, the control box 48 contains batteries (not shown) for providing electrical power to the motor and a microprocessor 54 (FIG. 2) for controlling operation of the motor. A solar panel 55 is mounted on the front wall 19 of the container 2. A wire 56 extends between the panel 55 and the batteries in the box 48 for charging the batteries. The microprocessor is programmed so that at predetermined timed intervals during the day, the gates 21 and 22 are opened, permitting access to the feed through the openings 18 in the front and rear walls 19 and 20 of the container 2.

When loading feed into the container 2, the lid 17 is removed from the top of the container 2. Bales of hay are loaded into the container 2 by turning them sideways. The height of the posts 5 is such that when the container 2 is rotated to the loading position (shown in phantom outline in FIG. 5), the open top end of the container is at the height of a tailgate of a pick-up truck which reduces the amount of lifting required during loading. The container 2 can be loaded with enough bales of hay to provide feed for several days before it becomes necessary to load more feed. The lid 17 is replaced on the open top end of the container 2 and the container is returned to the vertical, feeding position shown in FIGS. 1 to 5, permitting gravity to move the feed toward the bottom of the container.

The microprocessor 54 is programed to operate the motor 49 at predetermined times to fully open the gates 21 and 22. After a preselected interval, the motor 29 is operated in reverse to close the gates 21 and 22. The microprocessor 54 can be programed to open and close the gates 21 and 22 any number of times and for any intervals during the day.

1. An animal feeder comprising a stand; a container mounted on the stand, the container including a front wall, a rear wall, a pair of opposed side walls, a top opening, a closed bottom end and a lid on the top opening for protecting feed in the container from the elements; a bottom opening proximate a lower end of at least one of said front and rear walls; a gate normally closing said bottom opening; a cable having a first end attached to a top end of the gate; a winch carrying a second end of the cable; and a control assembly for periodically operating the winch to wind or unwind the cable on the winch to open the gate at predetermined times permitting access to the feed, and for closing the gate after preselected intervals to prevent further access to the feed.

2. The animal feeder of claim 1, wherein the control assembly includes a reversible motor for operating the winch, a source of electrical power for operating said motor, and a microprocessor for controlling operation of the motor to wind or unwind the cable on the winch, causing the gate to open or close.

3. The animal feeder of claim 2, including bottom openings proximate the lower ends of both the front and rear walls of the container, cables having first ends attached to the top ends of the gates, and the winch carrying second ends of the cables for simultaneously opening and closing the gates.

4. The animal feeder of claim 2, wherein said source of electrical power includes a battery and a solar panel mounted on said container for charging the battery.

5. The animal feeder of claim 1, wherein the container is rotatable on the stand for movement between a horizontal feed loading position in which the top opening is accessible for loading the container with feed, and a vertical feeding position permitting gravity to move the feed from the top toward the bottom of the container.

6. The animal feeder of claim 5, wherein the stand includes a pair of spaced apart, parallel feet, a pair of spaced apart crossbars interconnecting the feet; a post extending vertically upwardly from the center of each foot; and diagonal braces extending between the feet and the post.

7. The animal feeder of claim 5, including a pair of stops on each side of the container for limiting rotation of the container to the horizontal feed loading position or the vertical feeding position.
